(19) United States
(12) Patent Application Publication
(10) Pub. No.: US 2025/0348400 A1
(43) Pub. Date: Nov. 13, 2025

(54) GENERATING ARCHITECTURAL AND BEHAVIORAL SYSTEM MODELS FOR AUTONOMOUS SYSTEMS AND APPLICATIONS

(71) Applicant: NVIDIA Corporation, Santa Clara, CA (US)

(72) Inventors: Sam Gunn, Los Angeles, CA (US); Elliot Simon, San Diego, CA (US); Arul Sekar, Bothell, WA (US); Barry Hon, Chino Hills, CA (US)

(21) Appl. No.: 18/662,241

(22) Filed: May 13, 2024

(51) Int. Cl. G06F 11/32

(52) U.S. Cl. CPC G06F 11/328; G06F 11/323

(57) ABSTRACT

Embodiments of the present disclosure may relate to a method of generating a model of a system (e.g., a computing system), where the model may include one or more of a structural or architectural model and a behavioral or dynamic model. In some embodiments, the method may include obtaining data that may indicate one or more elements associated with functionality of a system (e.g., one or more software elements and/or hardware components). In some embodiments, the method may additionally include determining one or more operational dependencies corresponding to the one or more elements associated with the functionality of the system. Further, the method may include generating a model of the system based at least on the obtained data, the one or more elements, and the determined operational dependencies.

### BACKGROUND

Computing systems (referred to herein generally as “systems”) generally include an interplay between software and hardware. Typically, functionality defined, specified, or otherwise indicated in the software may be executed using one or more hardware components associated with the system. In some instances, one or more software elements may be included in the software functionality and may be associated with the hardware components and/or other software elements corresponding to the system.

In systems, and particularly in complex systems, as the number of hardware components increases, the functionality of the software may become more complex and the interplay between the software functionality and the hardware components may correspondingly increase in complexity. In addition, increased system complexity may lead to additional hardware components, hardware sub-components, software elements, software sub-elements, etc. The additional software elements and hardware components may all coordinate and communicate with one or more of the other software elements, sub-elements, hardware components, hardware sub-components, etc.

In some instances, challenges associated with complex systems become even more difficult to handle due—at least in part—to changes in hardware and/or software associated with the system often causing and/or affecting one or more changes to other hardware and/or software associated with the system. This is particularly true of complex systems that include many hardware components and significant functionality defined by software. In these instances, it may be important for developers, artificial intelligence (AI) systems, machine learning (ML) systems, etc. to understand how changes to one part/element/component of the system may affect other parts/elements/components of the system. This is particularly true in cases where several teams of systems and developers individually affect change in disparate parts of the system.

One or more traditional approaches to managing complex systems may include manually updating one or more system visualizations (e.g., system maps, diagrams, visualizations, etc.). In many instances, developers and others use the visualizations to properly manage the complex interplay between hardware components and software elements. In some instances, the visualizations may be limited in showing only the entire system, or—in the alternative—an abbreviated version of the system, both the entire system visualization and the abbreviated version of the system have limited utility.

In instances where the system map or visualization may illustrate an abbreviated version of the system, the visualization may not provide the detail required for developers to confidently make substantive changes to the system (e.g., eliminate elements, add elements, change inputs, change outputs, etc.) without understanding various repercussions, changes, or problems that may be caused for one or more other elements or components included in the system. In addition, an abbreviated system visualization may only track significant changes that may affect significant portions of the system. As such, it may be difficult to understand, digest, or otherwise consume the functionality of the system based on the abbreviated visualization.

In instances where the full complexity of the system is contemplated or shown in the visualization, the utility of the visualization may reflect the complexity of the system itself. In these instances, the visualization may not be easily digestible, which leads to lower confidence that changes to the system will be accurately or sufficiently effectuated by one or more developers, systems, teams, and others. Moreover, in some instances, even if change is properly effectuated, it may be difficult to determine what effects those changes may have on the system in part because of the complexity of the visualization itself. As such, neither an abbreviated, consumable system visualization nor a complex, fully comprehensive system visualization may be useful in tracking the interplay between software functionality and hardware components associated with the system. These limitations or shortcomings in the current visualizations become increasingly problematic as systems increase in complexity and, as a result, the interplay between software functionality and hardware components becomes increasingly complex.

### SUMMARY

According to one or more embodiments of the present disclosure, data may be obtained and/or used to generate an interactive, consumable model that may be used to generate one or more visualizations that may illustrate structural and/or operational relationships between one or more elements included in a system (e.g., a computing system). In some embodiments, the model may include data and/or information that may be queried or otherwise manipulated to generate a visualization of the system, in whole or in part. In some embodiments, the model may be automatically updating based on additional information, data, changes to the system, etc. corresponding to the software and/or hardware included in the system. The visualizations described herein may be more consumable and may increase the efficacy with which developers may rely on the visualizations to make hardware or software changes to the system as compared with previously conceived manually updated visualizations. In addition, the information corresponding to the model(s) and/or visualization(s) may be consumed and/or used in safety-hardened products. In some instances, the models and/or visualizations may be used for safety verifications and/or certification.

In some embodiments, a method used to generate the model may be disclosed. In some embodiments, the method may include obtaining data. In some embodiments, the data may include multiple elements that may be individually associated with functionality of the system. In some embodiments, the obtained data may include first data and second data.

In some embodiments, the first data may indicate structural relationships between one or more of the elements, where the structural relationships may indicate one or more software elements or hardware components that are structurally dependent on one or more other elements included in the system. In some embodiments, the first data may include one or more other dependencies such as, for example, operational dependencies, where operational dependencies may include one or more elements whose operation may depend on operations associated with other elements (e.g., software elements and/or hardware components).

Additionally or alternatively, the first data may indicate one or more execution environments that may include one or more hardware components that may be associated with executing one or more of the elements corresponding to the system. Further, in some embodiments, the first data may include one or more links that may indicate possible interaction between two or more elements of the system. In some embodiments, the first data may be associated with one or more levels of abstraction that may correspond to one or more of the elements and the one or more execution environments.

In some embodiments, the second data may indicate behavioral relationships between one or more of the elements corresponding to the system. In some embodiments, the behavioral relationships that may be indicated by the second data may indicate operations that may be performed using the elements corresponding to the system and a subset of the elements that may have been affected by the operations performed. In some embodiments, the second data may indicate one or more logical interfaces, where each of the logical interfaces may include one or more conceptual representations that may indicate interactions between one or more elements. For example, the logical interfaces may indicate behaviors that may be expected between elements over, for example, a shared boundary (e.g., an API, network protocols, database interfaces, component interfaces, virtual interfaces, etc.). In some embodiments, the second data may include one or more levels of abstraction that may correspond to the logical interfaces and the interactions.

In some embodiments, one or more operational dependencies may be determined, where the operational dependencies respectively correspond to one or more of the elements indicated in the obtained data. In some embodiments, the operational dependencies may be determined or otherwise derived using the obtained data and may include operations of one elements that may depend on operations of at least one other element associated with the system. In some embodiments, one or more structural dependencies may be determined based on the first data, where the structural dependencies may indicate how elements are related to one another within the system. In some embodiments, a linear progression may be determined based on the second data where events are individually defined by respective interactions between two or more elements corresponding to the system.

In some embodiments, the model of the system may be generated based on the obtained data (e.g., the first data and/or the second data), the plurality of elements, and the determined operational dependencies. Additionally or alternatively, the model may be generated based on the determined structural dependencies and/or the level of abstraction. Further, in some embodiments, the generated model of the system may be configured to be queried or otherwise modified using one or more sources—e.g., a user, a system, a large language model, a machine learning model, a deep neural network, etc. In some embodiments, based at least on the input and the generated models, one or more visualizations may be generated where the one or more visualizations may represent one or more portions of the generated model.

### BRIEF DESCRIPTION OF THE DRAWINGS

The present systems and methods correspond to generating one or more models and/or visualizations (e.g., architectural and/or behavioral models and/or visualizations) associated with a particular computing system, wherein:

FIG. 1 illustrates an example environment for generating an output using a model generation tool, in accordance with one or more embodiments of the present disclosure;

FIG. 2 illustrates an example environment for generating an output, in accordance with one or more embodiments of the present disclosure;

FIG. 3A illustrates an example visualization showing an example architectural model, in accordance with one or more embodiments of the present disclosure;

FIG. 3B illustrates an example visualization showing an example visual representation of a behavioral model, in accordance with one or more embodiments of the present disclosure;

FIG. 4 is a flow diagram showing a method for generating one or more models associated with a system, in accordance with one or more embodiments of the present disclosure;

FIG. 5A is an illustration of an example autonomous vehicle, in accordance with one or more embodiments of the present disclosure;

FIG. 5B is an example of camera locations and fields of view for the example autonomous vehicle of FIG. 5A, in accordance with one or more embodiments of the present disclosure;

FIG. 5C is a block diagram of an example system architecture for the example autonomous vehicle of FIG. 5A, in accordance with one or more embodiments of the present disclosure;

FIG. 5D is a system diagram for communication between cloud-based server(s) and the example autonomous vehicle of FIG. 5A, in accordance with one or more embodiments of the present disclosure;

FIG. 6 is a block diagram of an example computing device suitable for use in implementing one or more embodiments of the present disclosure; and

FIG. 7 is a block diagram of an example data center suitable for use in implementing one or more embodiments of the present disclosure.

### DETAILED DESCRIPTION

Computing systems (referred to herein generally as “systems”) generally include an interplay between software and hardware. Typically, functionality defined, specified, or otherwise indicated in the software may be executed using one or more hardware components associated with the system. In some instances, one or more software elements may be included in the software functionality and may be associated with the hardware components and/or other software elements corresponding to the system. As referred to generally in the present disclosure, “element” may refer generally to one or more software elements and/or one or more hardware components associated with a system.

As used in the present disclosure, “hardware component” may refer to a physical part, sub-part, portion, sub-portion, etc. that may correspond to a particular computing system, electronic device, etc. In some instances, the hardware components may be used to perform one or more functions corresponding to the system based on the type of hardware component. For example, one or more hardware components corresponding to a system may include one or more central processing units (CPUs), graphics processing units (GPUs), power supply units (PSUs) motherboards, Input/Output (I/O) devices, memory—e.g., random access memory (RAM), read-only memory (ROM), accelerators, data processing units (DPUs), tensor processing units (TPUs), etc. In some instances, the term “component” may also refer to one or more sub-components or child components. For example, a component may be a CPU which may include one or more sub-components such as, for example, arithmetic logic units (ALUs), control units, etc.

In addition, “software element,” as used herein describes, specifies, defines, and/or otherwise indicates particular features or functionality included in a software system. In some instances, a software element may include code and routines that may be configured to allow a computing system to perform one or more operations. In some instances, the software elements may be implemented using various hardware including hardware components as described, for example, above. In some instances, software elements may be executed and/or implemented using a combination of hardware and software. In some instances, individual software elements may include particularly defined and/or discrete functionality, where the functionality may accommodate various inputs, outputs, may perform certain functions, may communicate and/or link to various other software elements and/or hardware components within the system, etc.

In some instances, software elements may include software sub-elements or software child elements that may include one or more operations or functionality within the software element. For example, a software element may include a data management element that may be configured to manage storage, retrieval, and/or manipulation of data within the system. Continuing the example, the data management element may include one or more sub-elements, such as, for example, a first sub-element that may organize data within the system, a second sub-element that may index the data, a third sub-element that may generate queries corresponding to data management, etc. In some instances, software elements may change depending on the configuration of the system, changes to the code associated with the software, etc.

One or more embodiments of the present disclosure may include generating one or more models that may be associated with a particular system. In some embodiments, the one or more models may include one or more elements (e.g., software elements and/or hardware components) associated with the particular system. In some embodiments, the one or more models may include each of the elements associated with the particular system. In some embodiments, one or more visualizations may be generated based on the models that may depict structural and/or behavioral relationships between elements in the system.

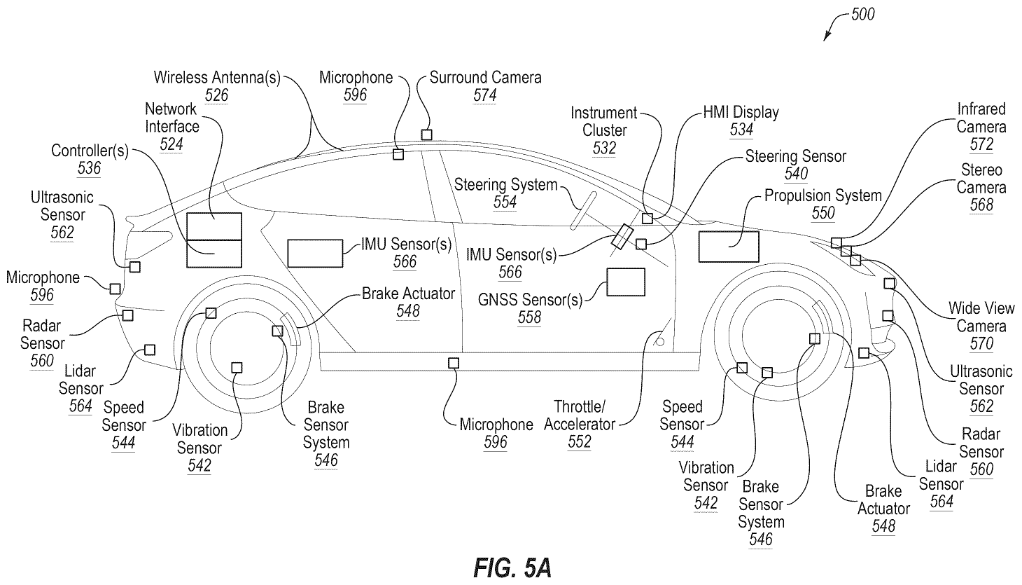

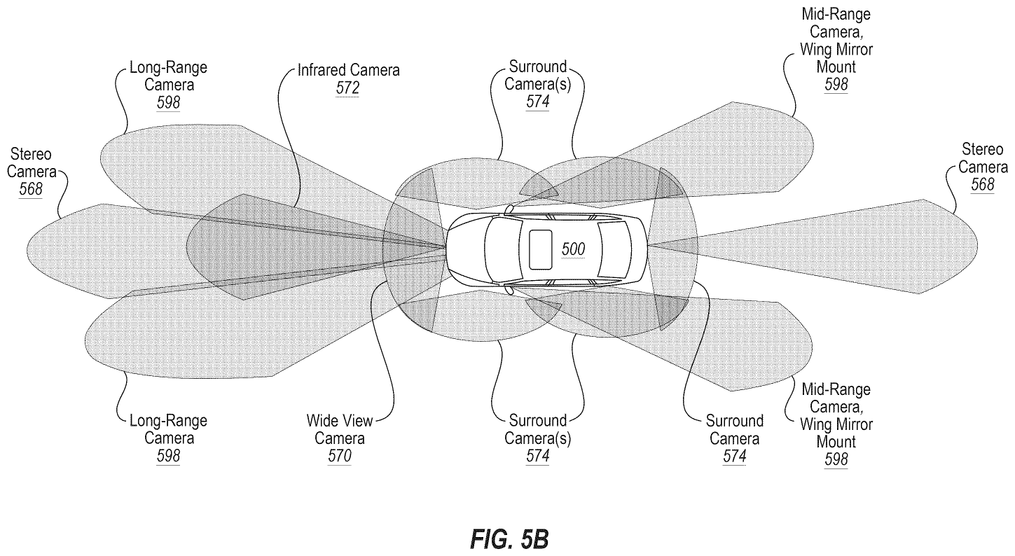

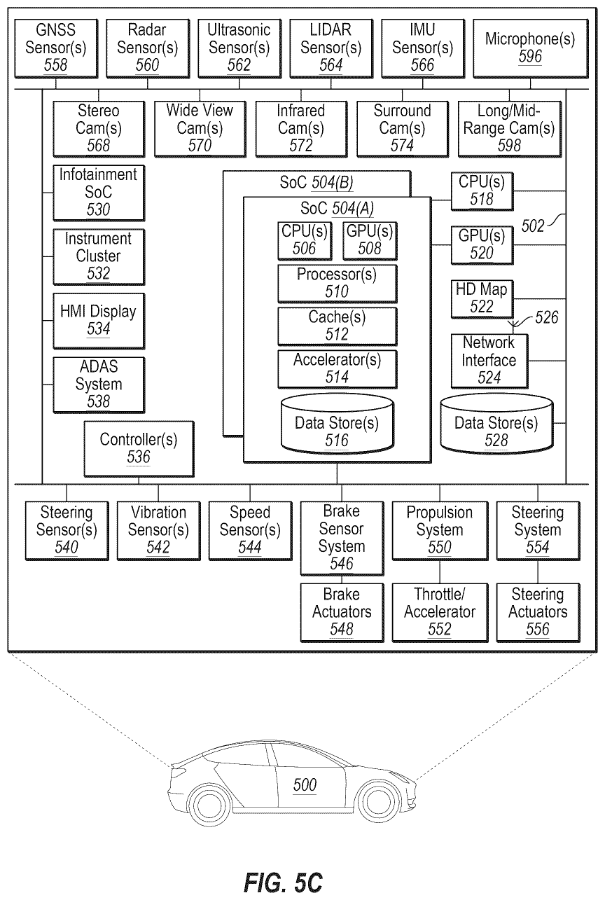

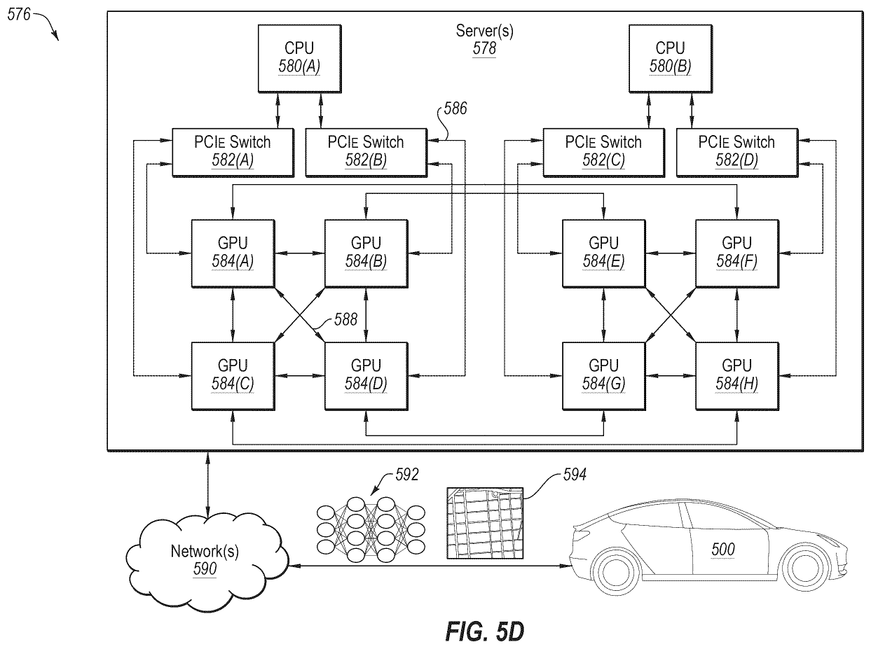

One or more of the embodiments disclosed herein may relate to generating one or more system models, where the system may be included in the context of an ego-machine. Additionally or alternatively, one or more embodiments may include modifying one or more aspects, characteristics, behaviors, etc. corresponding to an ego-machine based on the generated model(s). In some embodiments, the ego-machine may include any applicable machine or system that is capable of performing one or more autonomous and/or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous or semi-autonomous vehicle or machine 500 (alternatively referred to herein as “vehicle 500” or “ego-machine 500) described with respect to FIGS. 5A-5D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that implement one or more language models, such as one or more large language models (LLMs) that process textual, audio, image, sensor, and/or other data types to generate one or more outputs, systems that implement one or more vision language models (VLMs) systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

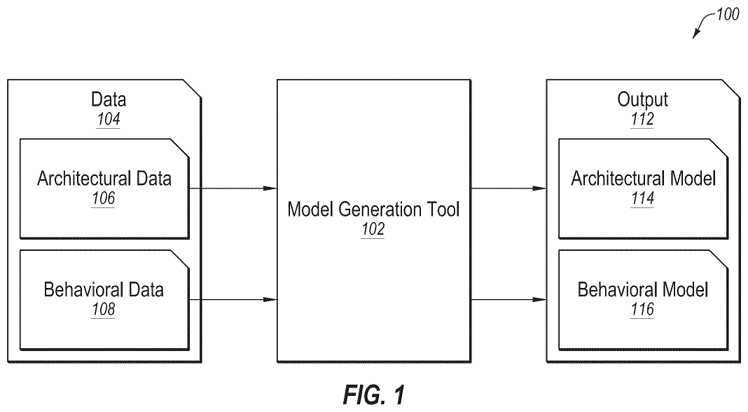

Now referring to FIG. 1, FIG. 1 illustrates an example environment 100 for generating an output 112 using a model generation tool 102, in accordance with one or more embodiments of the present disclosure. In some embodiments, the model generation tool 102 may be configured to receive or otherwise obtain data 104 and generate an output 112. In some embodiments, the output 112 may be generated based on data 104 that may be received or otherwise obtained by the model generation tool 102.

In some embodiments, the data 104 may correspond to a particular computing system, subsystem, machine, device, etc. For example, the data 104 may correspond to a particular machine (e.g., a particular vehicle, drone, electronic device, communication device, gaming device, automation device, etc.). Additionally or alternatively, the data 104 may correspond to a particular subsystem. For example, in the context of autonomous vehicles, the data 104 may correspond to a perception subsystem, a localization subsystem, a diagnostic subsystem, a mapping subsystem, a communication subsystem, a control subsystem, etc. Additionally or alternatively, the data 104 may correspond to one or more portions of a subsystem, for example, within a perception subsystem, the data 104 may correspond to one or more ML models and/or deep neural networks (DNNs) associated with the perception subsystem. Additionally or alternatively, the data 104 may correspond to a system that may include a collection of subsystems. For example, again in the context of an autonomous vehicle, the data 104 may correspond to each of the subsystems associated with the autonomous vehicle and any interconnectivity between the subsystems included in the autonomous vehicle. Continuing the example, the data 104 may correspond to the system as a whole, where the system includes various sub-systems and interconnectivity therein.

In some embodiments, the data 104 may indicate one or more aspects of a particular system. For example, the data 104 may indicate the presence of one or more software elements corresponding to the particular system. Continuing the example, the data 104 may include details associated with the software elements, such as, for example, what respective software elements may accept as inputs, what the software element may output, what execution environments may correspond to the software element, what functionality is defined by the software element, etc. Additionally or alternatively, the data 104 may indicate presence of one or more hardware components that may be associated with the particular system. For example, the data 104 may include driver information, device information, resource allocation information, etc. that may correspond to one or more of the hardware components that may be included in the particular system.

In some embodiments, the data 104 may be included in one or more specification sheets or files that may correspond to development of the particular system. For example, in some instances, one or more software developers may generate one or more files that may include data and/or information that may define elements within a system. Additionally or alternatively, the data 104 may be included in source code, files, logs, registration entries, etc. In some embodiments, the data 104 may include various types of data that may be represented in a first category—e.g., architectural data 106 and a second category—e.g., behavioral data 108.

The architectural data 106 may indicate one or more structural or architectural aspects, characteristics, attributes, etc. corresponding to the particular system. In some embodiments, the architectural data 106 may describe and/or indicate structure, organization, and interactions of various elements within the particular system. For example, in some embodiments, the architectural data 106 indicates how the particular system may be designed and how different elements may relate to each other.

In these and other embodiments, the architectural data 106 may include data and/or information respectively corresponding to one or more individual software elements. For example, in some embodiments, the information included in the architectural data 106 may define and/or indicate functionality respectively associated with the software elements. In some embodiments, the architectural data 106 may include the source code or information corresponding to the source code that may be associated with the system and various elements (e.g., the software elements and/or the hardware components). For instance, the architectural data 106 may indicate code or routines of the source code that may outline the functionality associated with respective software elements. Continuing the example, by indicating particular code and/or routines associated with the functionality of respective software elements, the outer bounds of respective software elements may be identified.

In some embodiments, the architectural data 106 may additionally include information and/or indicators that may identify one or more structural dependencies corresponding to one or more software elements and/or one or more hardware components. In some embodiments, the structural dependencies may describe and/or indicate relationships between elements. For example, a software element may include a data management element that may be configured to manage storage, retrieval, and/or manipulation of data within the system. Continuing the example, the data management element may include one or more sub-elements, such as, for example, a first sub-element that may organize data within the system, a second sub-element that may index the data, a third sub-element that may generate queries corresponding to data management, etc. Further, in some embodiments, one or more of the sub-elements may include one or more structural dependencies. In some embodiments, the architectural data 106 may include each of the structural dependencies that may correspond to each of the software elements that may be included in the particular system.

Additionally or alternatively, in some embodiments, the architectural data 106 may include one or more structural dependencies that may correspond to one or more hardware components. For example, one or more hardware components corresponding to the particular system may include a CPU. Continuing the example, the CPU may include one or more sub-components, such as, for example, arithmetic logic units (ALUs), control units, etc. In some embodiments, the architectural data 106 may include each of the structural dependencies that may correspond to each of the hardware components included the particular system.

Additionally or alternatively, in some embodiments, the architectural data 106 may indicate one or more relationships between software elements and hardware components. For example, continuing in the context of the data management element as one of the software elements included in a system, the data management element may be structurally dependent on one or more hardware elements. For example, the data management element may be dependent on operations executed by one or more CPUs associated with the system. Continuing the example, one or more other hardware components (e.g., CPUs, GPUs, control units, etc.) may depend on the data management element. For example, one or more hardware components may depend on operations performed by the data management element, one or more outputs corresponding to the data management element, etc.

In some embodiments, the architectural data 106 may indicate one or more execution environments through which operations corresponding to the one or more elements may be executed, corresponding hardware components or sub-components that may be used to execute the one or more operations, etc. For example, execution environments may include one or more applications, servers, virtual machines (VMs), platforms, etc. on which one or more software elements and/or portions of code or routines associated with one or more software elements may be executed. In some embodiments, the execution environments may correspond to a software element, a hardware component, and/or a combination of various software elements and hardware components.

In some embodiments, elements may include one or more portions of code or routines that may be executed. In some embodiments, the portion of code, instances, or software corresponding to an element that may be executed may be referred to as an instance. In some embodiments, one or more instances may be included in respective elements of the system. For example, an element may include one or more instances that may include a library in use by one or more processes, one or more applications, one or more drivers, to name a few.

In some embodiments, the architectural data 106 may indicate one or more links between elements. In the present disclosure, a link may refer to a connection between two or more instances or two or more elements. In some embodiments, one or more elements may rely on one or more other elements to fulfill its functionality. For example, a first element may pass a parameter to a second element. Continuing the example, passing the parameter from the first element to the second element may represent and/or indicate a link between the first element and the second element. In some embodiments, links may include function calls, parameter passing, instantiation, data access, and/or other connections between two or more elements.

In some embodiments, the architectural data 106 may indicate one or more logical interfaces between one or more software elements. In some embodiments, the one or more logical interfaces may refer to conceptual representations that may indicate interactions between elements and/or components within a system. In some embodiments, a logical interface may provide a conceptual framework or model for communication and interaction between elements. In some embodiments, the logical interface may indicate rules, protocols, behaviors, etc. that may govern or describe interactions between elements. In some embodiments, logical interfaces may refer to the high-level representation of communication and interaction between elements.

For example, logical interfaces may indicate one or more events that may occur between elements over a shared boundary (e.g., an API, a virtual interface, etc.). In some embodiments, one or more logical interfaces may describe the interaction between two or more elements and may include various events that may occur between the two or more elements. In some embodiments, events may include data transfer events; for example, elements may be configured to send or receive data packets, one or more files may be read from or written to one or more databases, one or more messages may be exchanged between elements, etc. Additionally or alternatively, events may include synchronization/coordination events; for example, elements may be configured to synchronize various processes, coordinate execution of various operations, etc. Additionally or alternatively, events may include notification events; for example, elements may be configured to report one or more errors to one or more other elements, one or more notifications or changes may be communicated to one or more other elements, etc.

In some embodiments, logical interfaces may be implemented using, for example, one or more virtual interfaces that define and/or otherwise indicate communication protocols, formats, methods, etc. that may be used for interaction between two or more software elements, hardware components, etc. For example, a logical interface may be implemented using an application programming interface (API) that may define a set of rules, protocols, and/or tools that may enable communication between software elements. As an additional example, the logical interfaces may be implemented using database interfaces that may provide access points to allow interaction with a database such as, for example, retrieving data, updating data, removing data, etc. included in the database.

In some embodiments, the behavioral data 108 may also be included in the data 104. In some embodiments, the behavioral data 108 may indicate one or more behavioral characteristics corresponding to individual elements included in the system. In some embodiments, the behavioral data 108 may indicate one or more operations that may be performed by the individual elements associated with the system. In these and other embodiments, the behavioral data 108 may indicate interactions between various elements associated with the system.

In some embodiments, the behavioral data 108 may indicate one or more events. In some embodiments, events may include interactions between elements over an interface. Additionally or alternatively, events may be limited to inputs, outputs, and actions within a particular element. For example, in some embodiments, the behavioral data 108 may indicate one or more inputs that may be accepted by individual elements, one or more outputs that may be generated using individual elements, etc.

In some embodiments, the behavioral data 108 may indicate and/or define the events, inputs, outputs, interactions, etc. on a modular or an element-by-element basis. In some embodiments, by independently defining various aspects of the system based on individual elements, the definitions become much simpler than explicitly defining all possible linear sequences. In some embodiments, the model generation tool 102 may be configured to automatically derive operational relationships between one or more elements in the system based on the modular definitions that may be provided on an element-by-element basis. The automatic derivation allows for automatic changes to system models based on changes to one or more elements associated with the system. In some embodiments, the data 104 including the architectural data 106 and/or the behavioral data 108 may be transmitted, communicated, or otherwise obtained by the model generation tool 102.

The model generation tool 102 may include one or more systems that may be configured to generate one or more models (e.g., an architectural model 114 and/or a behavioral model 116) based on the data 104. In some embodiments, the model generation tool 102 may be a standalone system that may receive the data 104 from one or more different sources corresponding to the computing system to which the models (e.g., the architectural model 114 and/or the behavioral model 116) may correspond. Additionally or alternatively, the model generation tool 102 may be included in one or more other systems, such as, for example, the computing system and/or machine to which the data 104 may correspond. In some embodiments, the model generation tool 102 may be configured to derive information corresponding to one or more elements based on the data 104. Additionally or alternatively, the model generation tool 102 may be configured to direct one or more other systems to perform one or more operations using the data 104 in order to generate the output 112. In some embodiments, the model generation tool may include one or more large language models (LLMs) and/or vision language models (VLMs) that may digest the data 104, as well as any change requests, in embodiments, and help in generating the models, updating visualizations, identifying hardware/software elements that are effected by the change request, etc.

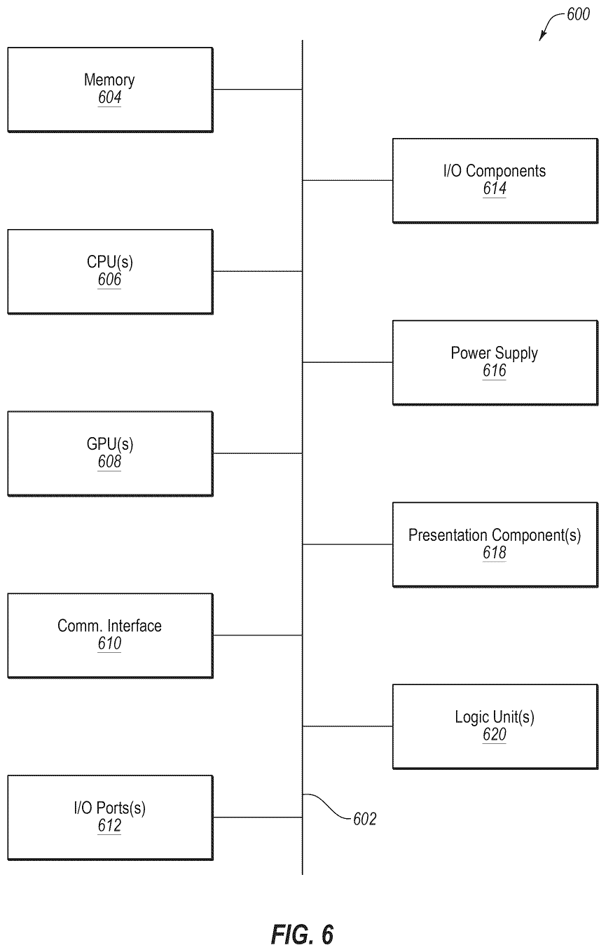

In some embodiments, the model generation tool 102 may include code and routines configured to allow a computing system to perform one or more operations. Additionally or alternatively, the model generation tool 102 may be implemented using hardware including one or more processors, CPUs, graphics processing units (GPUS), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, the model generation tool 102 may be implemented using a combination of hardware and software. In the present disclosure, operations described as being performed by the model generation tool 102 may include operations that the model generation tool 102 may direct a corresponding computing system to perform. In these or other embodiments, the model generation tool 102 may be implemented by one or more computing devices, such as that described in further detail with respect to FIGS. 5A-5D, 6, and/or 7.

In some embodiments, the model generation tool 102 may be configured to obtain the data 104 (e.g., the architectural data 106 and/or the behavioral data 108). In some embodiments, the model generation tool 102 may be configured to receive the data 104 from one or more different sources, systems, etc. For example, the model generation tool 102 may be configured to receive the data 104 from system schematics or other documents and/or files where various elements may be defined. In some embodiments, the system schematics may be drafted, created, modified, etc. using one or more systems, developers, etc. In some embodiments, the data 104 may be sent or otherwise communicated directly to the model generation tool 102 by one or more systems, programmers, etc. and, in those instances, the model generation tool 102 may be configured to receive any and all data 104 associated with the communication. Additionally or alternatively, the model generation tool 102 may be configured to pull or collect the data 104, where the data 104 may include source code associated with the system.

In some embodiments, the model generation tool 102 may be configured to collect and store the data 104 based on categories associated with annotations included in the data 104. Additionally or alternatively, the model generation tool 102 may be configured to derive, sort, categorize, etc. the data 104 into discernable elements including associated structure and/or behavior. In some embodiments, the model generation tool 102 may be configured to derive the functionality of various elements and components from the source code again based on attributes or features found in the source code. For example, the source code may indicate various inputs and outputs associated with individual elements, other elements and/or components that may be in communication, libraries from which individual elements may call for functions to be performed, etc. Continuing the example, based on the attributes of various portions of the source code, the inputs, outputs, communication links, etc. may be pulled, derived, and/or deduced.

In some embodiments, the model generation tool 102 may be configured to perform one or more operations associated with a static code analysis such that the model generation tool 102 may be configured to analyze the source code without executing the source code. In some embodiments, the operations corresponding to a static code analysis may allow the model generation tool 102 to extract information about structures, structural relationships, dependencies, and other relationships between elements included in the source code. As an example, the model generation tool 102 may perform one or more parsing operations using one or more source code files associated with the system. Continuing the example, the model generation tool 102 may extract information associated with classes, functions, variables, methods, and other code constructs that may be associated with particular elements of the system. Additionally or alternatively, other static code analysis operations that may be performed using the model generation tool 102 may include building abstract syntax trees representing the structure and hierarchies associated with elements in the system, analyzing code metrics such as coupling, cohesion, complexity, etc.

In some embodiments, the model generation tool 102 may be configured to perform one or more operations on the data 104 whether the data 104 be included in source code, logs, files, spec sheets outlined by developers, etc. In some embodiments, the model generation tool 102 may be configured to perform one or more operations associated with one or more analyses that may allow the model generation tool 102 to derive structural and/or behavioral relationships between elements indicated by the data 104 associated with a particular system. For example, the model generation tool 102 may perform one or more operations associated with a symbol resolution analysis, the analysis including resolving or comparing symbols (e.g., function calls, variable names, class references, to name a few) with definitions and other declarations in a code base (e.g., the source code of the system). Another example may include performing operations associated with a semantic analysis which may include analyzing type information, method signatures, hierarchies, and/or other semantic properties that may be associated with the data 104. As another example, the model generation tool 102 may perform operations associated with a dependency analysis to determine, for example, how different elements associated with the particular system depend on each other. Continuing the example, the dependency analysis may include analyzing import statements, function calls, and/or other language-specific constructs such that the model generation tool 102 may be configured to deduce or infer dependencies between elements, sub-elements, etc. As described herein, at least a portion of this analysis of the data 104 may be performed using one or more LLMs and/or VLMs.

In some embodiments, the model generation tool 102 may be configured to identify elements, links, dependencies-both structural and behavioral, execution environments, logical interfaces, etc. based on the data 104. In particular, the model generation tool 102 may be configured to derive elements (e.g., software elements and hardware components), links, dependencies-both structural and behavioral, execution environments, logical interfaces, etc. based on the architectural data 106. In some embodiments, the model generation tool 102 may be configured to store the data 104 along with the identified and/or derived relationships and other information corresponding to elements indicated by the data 104.

In some embodiments, the model generation tool 102 may be configured to derive and/or identify one or more sequences of events or potential sequences of events based on the data 104. In particular, the model generation tool 102 may be configured to derive sequences of events based on the behavioral data 108. In some embodiments, the model generation tool 102 may be configured to determine, derive, and/or deduce one or more sequences of events based on events that may be defined in the behavioral data 108. In some embodiments, rather than sequences defined by developers or rather than sequences being defined in the behavioral data 108, the model generation tool 102 may derive the sequences using the behavioral data 108.

In some embodiments, the sequences that may be derived may include, for example, one or more identified events, one or more calls to other events associated with elements in the system, associated responses between elements, outcomes, and potential variation included in processes associated with the elements included in the system. For example, the model generation tool 102 may be configured to stitch together modular definitions of isolated behavioral characteristics of elements—e.g., events, instances, etc. described, for example, with respect to behavioral data 108 above. In some embodiments, the model generation tool 102 may be configured to determine each of the potential sequences including various outcomes that may be based on particular inputs and outputs of elements included in the system. In some embodiments, the sequences may include events that may occur within a particular element and/or events that may occur between elements associated with the system.

In some embodiments, based on the information derived using the data 104 (e.g., the architectural data 106 and/or the behavioral data 108), the model generation tool 102 may be configured to generate an output 112.

In some embodiments, the output 112 may include the data 104 that may have been stored by the model generation tool 102. Additionally or alternatively, the output 112 may include the data 104 and all of the information derived from the data 104 using the model generation tool 102 (e.g., system architecture and/or structure, structural relationships, behavioral relationships, sequences, etc.). In some embodiments, the output 112 may include one or more models of the particular system associated with the data 104—e.g., one or more architectural models 114 and/or one or more behavioral models 116.

The architectural model 114 may include one or more structural models that may include system architecture-both software and hardware. For example, the architectural model 114 may include various software elements, links between software elements, execution environments and corresponding hardware components, etc. that may have been identified and/or derived using the model generation tool 102.

In some embodiments, the architectural model 114 may include each of the elements, sub-elements, execution environments, hardware components, sub-components, links, etc. that may describe and/or illustrate the system architecture in its entirety. In some embodiments, the architectural model 114 may include information corresponding to the system that may be organized in a hierarchical fashion. For example, particularly in complex systems, the information may be grouped hierarchically. For example, the architectural model 114 may include various levels of abstraction corresponding to the architecture of the system. In some embodiments, the various levels of abstraction may correspond to different levels of detail and/or granularity with which data and/or information associated with the system may be organized. For example, a first level of abstraction may include the system (e.g., elements associated with the system) at its broadest conceptual level—e.g., a representation of the system and one or more main elements within the system. Continuing the example, the second level of abstraction may include various elements included in the main elements within the system, links corresponding to those elements, execution environments corresponding thereto, etc. Further continuing the example, the third level of abstraction may include sub-elements within the elements associated with the main elements of the system. The levels of abstraction may continue based on the complexity of the system, the number of elements, the sub-elements corresponding to the elements, etc.

In some embodiments, the architectural model 114 may be queryable or otherwise modifiable such that information corresponding to various hierarchical tiers may be accessible based on a query, for example, queries or other forms of input indicating a particular level of abstraction, execution environment, element, etc.

The behavioral model 116 may indicate a progression of operations between elements. In some embodiments, the behavioral model 116 may include data and/or information corresponding to a linear progression of operations between elements. An example of a linear progression may include: a first element may send a query to a second element, the second element may perform one or more operations based on the query, including, for example, communicating a response back to the first element. Continuing the example, the behavioral model 116 may include data and/or information that may indicate back-and-forth communication and operations between elements corresponding to the system.

In some embodiments, like the architectural model 114, the behavioral model 116 may include information corresponding to the system that may be organized in a hierarchical fashion. For example, particularly in complex systems, the information may be grouped hierarchically. For example, the behavioral model 116 may include various levels of abstraction corresponding to the architecture of the system. In some embodiments, the various levels of abstraction may correspond to different levels of detail and/or granularity with which data and/or information associated with the system may be organized. For example, a first level of abstraction may include one or more sequences of events between elements of the system at its broadest conceptual level—e.g., a representation of the events and/or operations performed between one or more main elements within the system. Continuing the example, the second level of abstraction may include events, sequences, and linear progressions of events included within the main elements within the system, etc. Further continuing the example, the third level of abstraction may include events, sequences, and linear progressions of events corresponding to sub-elements within the elements associated with the main elements of the system. The levels of abstraction may continue based on the complexity of the system, the number of elements, the sub-elements corresponding to the elements, etc.

In some embodiments, changes to the level of abstraction may be reflected in changes to the elements and/or sub-elements, logical interfaces, and/or hardware components that may be illustrated in the behavioral model 116. In some embodiments, the behavioral model 116 may be queryable, alterable, or otherwise able to be modified based on the level of abstraction. For example, the behavioral model 116 may be modified and/or queried using a system or user that may specify a desired level of abstraction, an element of focus, an execution environment of focus, etc. from which to view the behavioral model 116.

Modifications, additions, or omissions may be made to FIG. 1 without departing from the scope of the present disclosure. For example, the amount of data 104, the number of systems, subsystems, processes, etc. that may be associated with the model generation tool 102, the amount and/or type of the output 112, the number of architectural models 114 and/or behavioral models 116, etc. may vary. The specifics given and discussed are to help provide explanation and understanding of concepts of the present disclosure and are not meant to be limiting.

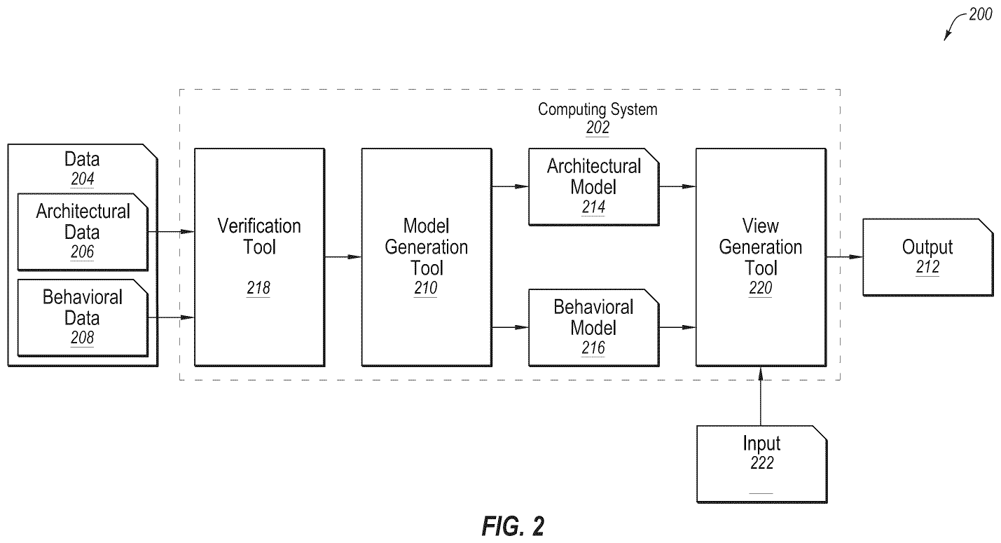

FIG. 2 illustrates an example environment 200 for generating an output 212, in accordance with one or more embodiments of the present disclosure. In some embodiments, the environment 200 may be the same as and/or an example implementation of the environment 100 as described further in the present disclosure, such as, for example, with respect to FIG. 1. In some embodiments, the environment 200 may include a computing system 202 that may be configured to perform one or more operations using the data 204 to generate the output 212.

The data 204 may correspond to a particular system (e.g., a particular computing system). In some embodiments, the data 204 may include categories of data including architectural data 206 and/or behavioral data 208 that may correspond to the particular system. In these or other embodiments, the data 204, the architectural data 206, and the behavioral data 208 may be the same as and/or analogous to the data 104, the architectural data 106, and the behavioral data 108 that may be described and/or illustrated further in the present disclosure, such as, for example, with respect to FIG. 1.

In some embodiments, the data 204, which may include the architectural data 206 and/or the behavioral data 208, may be iteratively obtained. For example, one or more developers, Machine Learning (ML) models, Large Language Models (LLMs), etc. may be configured to adjust one or more aspects of the particular system to which the data 204 may correspond (e.g., by modifying the source code). In some embodiments, the data 204 may be transmitted to and/or received by the computing system 202. Additionally or alternatively, the data 204 may be collected and/or obtained using the computing system 202 and/or one or more systems, subsystems, machines, etc. that may be directed to collect, generate, or otherwise obtain the data 204 including, for example, the architectural data 206 and the behavioral data 208 using the computing system 202.

In some embodiments, the computing system 202 may include one or more systems, subsystems, machines, etc. that may be configured to perform one or more operations on the data 204 (e.g., to generate the output 212). In some embodiments, the computing system 202 may include one or more modules, systems, subsystems, etc. that may be configured to perform operations on the data 204. In some embodiments, the computing system 202 may be a standalone system that may perform operations on the data 204. Additionally or alternatively, the computing system 202 may be configured to direct one or more other machines, systems, subsystems, etc. to perform one or more operations on the data 204 (e.g., the architectural data 206 and/or the behavioral data 208). In some embodiments, the computing system 202 may include a verification tool 218, a model generation tool 210, and/or a view generation tool 220.

In some embodiments, the verification tool 218, the model generation tool 210, and/or the view generation tool 220 may include code and routines configured to allow a computing system to perform one or more operations. Additionally or alternatively, the verification tool 218, the model generation tool 210, and/or the view generation tool 220 may be implemented using hardware including one or more processors, CPUs graphics processing units (GPUs), data processing units (DPUs), parallel processing units (PPUs), microprocessors (e.g., to perform or control performance of one or more operations), TPUs, field-programmable gate arrays (FPGA), application-specific integrated circuits (ASICs), accelerators (e.g., deep learning accelerators (DLAs)), and/or other processor types. In these and other embodiments, the verification tool 218, the model generation tool 210, and/or the view generation tool 220 may be implemented using a combination of hardware and software. In the present disclosure, operations described as being performed by the verification tool 218, the model generation tool 210, and/or the view generation tool 220 may include operations that the respective modules individually or in combination may direct a corresponding computing system to perform. In these or other embodiments, the modules may be implemented by one or more computing devices, such as that described in further detail with respect to FIGS. 5A-5D, 6, and/or 7.

The verification tool 218 may be configured to check or verify that data 204 may match or comport with other data 204 that may correspond to a same system. In some embodiments, the data 204 may be iteratively obtained such that the data 204 may correspond to the same system. In some embodiments, the data 204 may indicate one or more changes to the system (e.g., changes to the source code associated with the system). In some embodiments, changes in the data 204 (e.g., one or more of the architectural data 206 and/or the behavioral data 208) may correspondingly change one or more of the generated models (e.g., the architectural model 214, the behavioral model 216, the architectural model 114 and/or the behavioral model 116). In some embodiments, the verification tool 218 may be configured to check the data 204 against data 204 that may have been received previously.

In some embodiments, the verification tool 218 may be configured to verify that changes in the data 204 may comport with elements and processes that may already be included in the system corresponding to the data 204. In some embodiments, changes to one portion of the data 204 may cause one or more changes throughout the system. As described previously, particularly complex systems may include many subsystems, elements (e.g., software elements and/or hardware components) such that changes to one portion of the system may cause one or more other changes throughout the system. In some instances, changing the data 204 may prevent one or more other portions of the system from functioning properly. In some embodiments, the verification tool 218 may prevent unintended errors from propagating throughout the system corresponding to the data 204.

In some embodiments, to verify that the changes to the data 204 may comport with previously obtained data 204, the verification tool 218 may receive the data 204 and check against previously obtained data 204. For example, systems, developers, etc. may submit the data 204 in one or more files, specs, etc. Continuing the example, after communicating the data 204 to the verification tool 218, the verification tool 218 may be configured to check the data 204 against previously obtained data 204. Further continuing the example, the verification tool 218 may then be configured to indicate one or more errors associated with changes to the data 204. Additionally or alternatively, the verification tool 218 may be configured to provide feedback in real time or substantially real time. For example, the verification tool 218 may be built into a compiler, where developers or other systems may be working to change the source code. For example, as a developer makes changes to the source code, the verification tool 218 may be configured to indicate one or more errors in real time or substantially real time while the changes are being made.

In some embodiments, the verification tool 218 may be configured to generate one or more notifications indicating a presence of one or more errors based on verifying changes to the data 204 against previously obtained data 204—e.g., using an LLM and/or VLM. In some embodiments, the generated notifications may indicate which portion of the changes to the data 204 may be problematic. In some embodiments, the notifications generated may indicate which other portion of the system corresponding to the data 204 may not function properly in response to one or more changes to the data 204. In some embodiments, the verification tool 218 may be configured to generate one or more notifications indicating that changes made to the data 204 may not adversely affect function associated with the corresponding system. In some embodiments, if changes to the data 204 may not include any errors that may have been determined by the verification tool 218, the data 204 may be sent, transmitted, or otherwise communicated to the model generation tool 210. If errors may have been detected, the verification tool 218 may prevent the communication or transmission of the data 204 unless and until the errors are fixed or accounted for.

In some embodiments, the model generation tool 210 may be configured to receive and/or obtain the data 204. In some embodiments, the data 204 may be obtained from the verification tool 218. Additionally or alternatively, the data 204 may be obtained from one or more different systems, modules, databases, file systems, etc. In some embodiments, the model generation tool 210 may be configured to perform one or more operations on the data 204 (e.g., the architectural data 206 and/or the behavioral data 208). In some embodiments, in response to changes in the data 204 that may correspond to a same system as previously received data 204, the model generation tool 210 may be configured to update the one or more models that may have been generated corresponding to the system.

In some embodiments, the model generation tool 210 may be configured to generate and/or update an architectural model 214 and/or a behavioral model 216 using the data 204. In these or other embodiments, the model generation tool 210, the architectural model 214 and/or the behavioral model 216 may be the same as and/or analogous to the model generation tool 110, the architectural model 114 and the behavioral model 116, respectively that may have been described and/or illustrated further in the present disclosure, such as, for example, with respect to FIG. 1. In some embodiments, the architectural model 214 and/or the behavioral model 216 may be sent, communicated, or otherwise obtained by the view generation tool 220.

In some embodiments, the view generation tool 220 may be configured to generate the output 212 based on the architectural model 214 and/or the behavioral model 216. Additionally or alternatively, the view generation tool 220 may be configured to generate the output 212 based on the architectural model 214, the behavioral model 216, and/or an input 222, where the view generation tool may be configured to receive the input 222.

The input 222 may include any text, image, file, data, etc. that may indicate one or more portions of the architectural model 214 and/or the behavioral model 216 to view. For example, the input 222 may include a user interface that may allow one or more users to select a portion of the architectural model 214 and/or behavioral model 216 that the user would like to view. In some embodiments, one or more other systems may be configured to generate an input to indicate particular portions of the architectural model 214 and/or the behavioral model 216 to view. For example, a DNN or LLM may generate one or more queries that may be designed to illicit a particular response from the view generation tool 220. Additionally or alternatively, different models and systems may be configured to designate a particular portion of the architectural model 214 and/or the behavioral model 216 for viewing. In some embodiments, the designated portion may be indicated by one or more inputs 222.

In some embodiments, the input 222 may be cabined to particular selections. For example, the input 222 may indicate a particular level of abstraction corresponding to the architectural model 214 and/or the behavioral model 216. In some embodiments, the input 222 may be modifiable or selected based on a number of criteria. In some embodiments, the input 222 may include, a level of abstraction, a particular element corresponding to the models, an execution environment associated with a particular model, etc. For example, the input 222 may indicate a first level of abstraction and an element corresponding to the model and level of abstraction. Continuing the example, the purpose of the input 222 may be to elicit a visualization of one or more of the architectural model 214 and/or the behavioral model 216 that includes the particular element selected at the first level of abstraction. In some embodiments, the input 222 may be changed and/or iteratively provided. Additionally or alternatively, the input 222 may be provided by one user, system, model, etc. Additionally or alternatively, the input 222 may be provided by multiple users, systems, models, etc.

In some embodiments, the view generation tool 220 may be configured to receive the inputs 222 via one or more graphical user interfaces (GUIs). Additionally or alternatively, the input 222 may be transmitted, sent, and/or otherwise communicated from one or more sources to the view generation tool 220. In some embodiments, the view generation tool 220 may be configured to receive and/or otherwise obtain the input 222.

In some embodiments, the view generation tool 220 may be configured to pull from data corresponding to the architectural model 214 and/or the behavioral model 216 in light of input 222 that may have been received. In some embodiments, the output 212 may be generated using the computing system 202. Additionally or alternatively, the output 212 may be sent, transmitted, or otherwise communicated to one or more alternative sources. Additionally or alternatively, the output 212 may be displayed visually to one or more users via a display or other user interface that may correspond to the computing system 202 and/or the view generation tool 220.

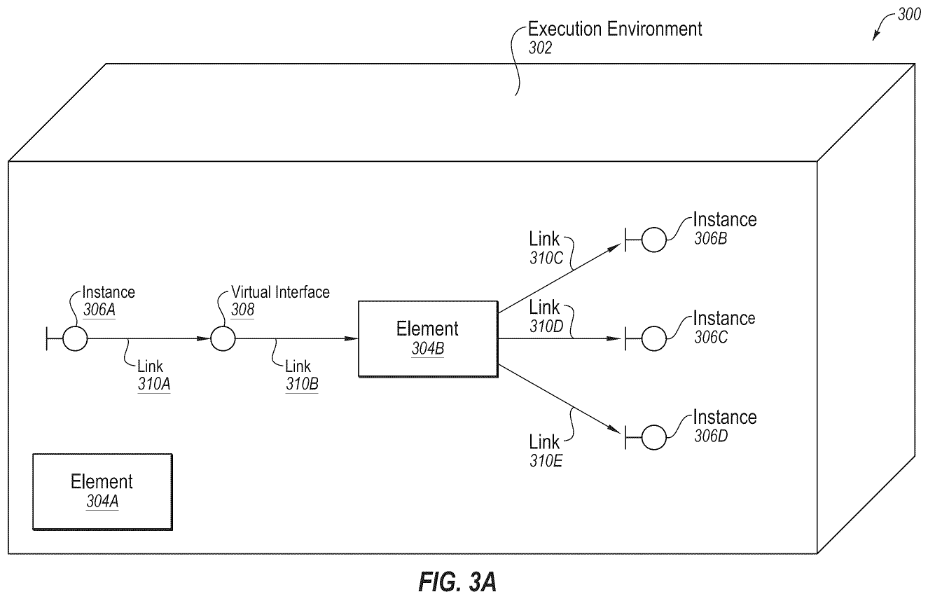

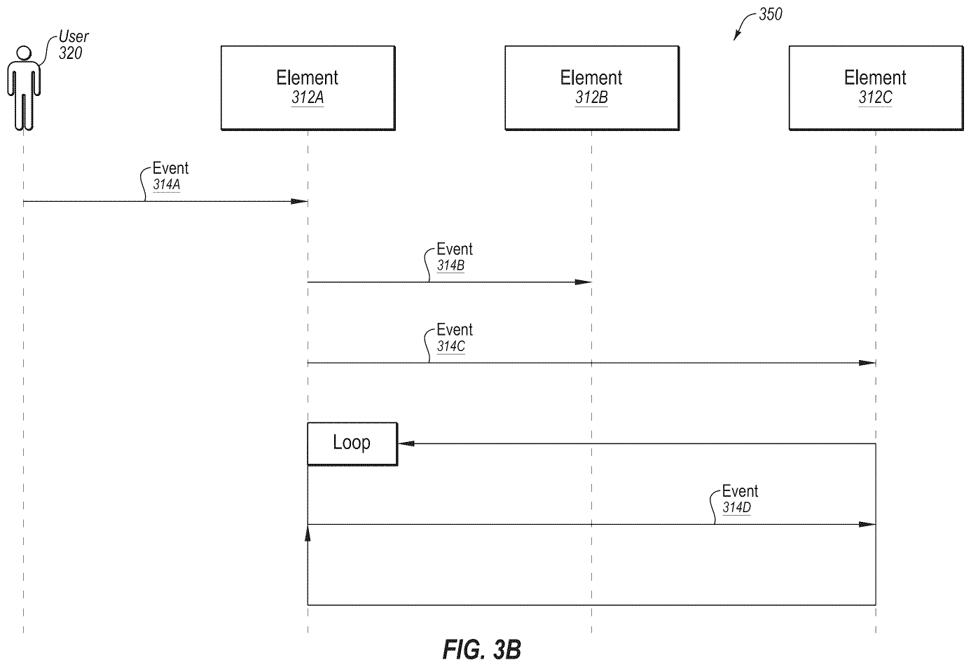

In some embodiments, the output 212 may include one or more visualizations of the architectural model 214 and/or the behavioral model 216 (collectively “the models”) based on the models and the input 222. In some embodiments, the output 212 may include one or more standardized indicators for various portions of the system corresponding to the models. For example, a visualization corresponding to a particular portion of the architectural model 214 may include a particular symbol or representation for an element (e.g., a software element or hardware component), another particular symbol or representation for a link, another for logical interfaces, another for an execution environment, another for an instance, etc. In some embodiments, the standardized symbols may be alterable, and may be consistent to properly illustrate the system corresponding to the architectural model 214. In some embodiments, standardized symbols and representations may be different for different models. For example, the output 212 may include a particular portion of the behavioral model 216 that may show and/or illustrate one or more sequences of events that may occur within a particular element or between elements. Continuing the example, the corresponding visualization may include a particular symbol or representation corresponding to an element, a link, inputs and outputs between elements, sub-elements, and others, etc. Example visualizations corresponding to the architectural model 214 and the behavioral model 216 may be described and/or illustrated further in the present disclosure, such as, for example, with respect to FIGS. 3A-3D.

Modifications, additions, or omissions may be made to FIG. 2 without departing from the scope of the present disclosure. For example, the amount of data 204, the number of computing systems 202, the number of tools (e.g., the verification tool 218, the model generation tool 210, and/or the view generation tool 220) may vary. Additionally or alternatively, the number of models (e.g., architectural models 214 and/or behavioral models 216) and/or corresponding views and/or visualizations generated based on the models may vary. The specifics given and discussed are to help provide explanation and understanding of concepts of the present disclosure and are not meant to be limiting.

FIG. 3A illustrates an example visualization 300 showing an example architectural model, in accordance with one or more embodiments of the present disclosure. In some embodiments, the visualization 300 may be an example of an output (e.g., the output 212) described and/or illustrated further in the present disclosure, such as, for example, with respect to FIG. 2. Additionally or alternatively, the visualization 300 may be an example visual representation of a portion of one or more architectural models described and/or illustrated further in the present disclosure, such as, for example, the architectural model 114 and/or the architectural model 214 in FIGS. 1 and/or 2.

The example visualization 300 shown in FIG. 3A may correspond to a particular level of abstraction corresponding to a particular system. In the case of FIG. 3A, the example visualization 300 may illustrate a level of abstraction that may be greater than a first level of abstraction (e.g., a tier 2 or tier 3 level of abstraction). In some embodiments, the tier 2 or tier 3 level of abstraction may illustrate one or more sub-elements that may be operating within a system.

As illustrated in FIG. 3A, the example visualization 300 illustrates an execution environment 302 where one or more operations may be executed. In some embodiments, the execution environment 302 may include one or more computing platforms, operating systems, runtime libraries, hardware configuration, etc. upon which one or more operations may be executed. In some embodiments, the execution environments 302 may include one or more characteristics of execution environments as described and/or illustrated further in the present disclosure, such as, for example, with respect to FIGS. 1 and 2.

The example visualization 300 may include one or more instances 306 (e.g., instance 306A, instance 306B, instance 306C, and instance 306D (collectively “instances”)). In some embodiments, instances 306 may indicate or represent portions of code and routines that may be executed and that may correspond to one or more elements. As illustrated in FIG. 3A, the instance may refer to portions of code or routines that may correspond to elements that may not be depicted in example visualization 300. In these or other embodiments, the instances 306 may be the same as and/or analogous to elements that may be described and/or illustrated further in the present disclosure, such as, for example, with respect to FIGS. 1 and 2. In some embodiments, and as shown in example visualization 300, the instances may interact with one or more elements (e.g., element 304B).

The example visualization 300 may additionally include one or more elements 304 (e.g., element 304A and element 304B). In some embodiments, element 304A and/or element 304B may indicate one or more defined elements. Additionally or alternatively, the element 304A and/or the element 304B may indicate an instance of element 304A and/or 304B within the execution environment 302. In some embodiments, another example visualization may illustrate one or more sub-elements, instances, links, etc. that may correspond to element 304A. Further, element 304B may interact with one or more instances 306. In these or other embodiments, the elements 304 may be the same as and/or analogous to elements that may be described and/or illustrated further in the present disclosure, such as, for example, with respect to FIGS. 1 and 2.

Further, the example visualization 300 may include one or more links—e.g., link 310A, link 310B, link 310C, link 310D, and/or link 310E (collectively “the links 310”). In some embodiments, the links 310 may illustrate one or more connections between elements 304 and instances 306. In some embodiments, the links 310 may indicate that data, outputs, inputs, etc. may be communicated between and/or affect one or more other elements 304 or instances 306. For example, as shown in example visualization 300, the link 310C may show a connection between element 304B and instance 306B which may indicate element 304B may affect execution of the instance 306B. In these or other embodiments, the links 310 may by the same as and/or analogous to links as described and/or illustrated further in the present disclosure, such as, for example, with respect to FIGS. 1 and 2.

Further, the example visualization 300 may include a virtual interface 308. The virtual interface 308 may indicate a boundary via which the instance 306A and the element 304B may interact. In some embodiments, the virtual interface 308 may illustrate an API through which instance 306A and element 304B may interact with each other. In these or other embodiments, the virtual interface 308 may by the same as and/or analogous to links as described and/or illustrated further in the present disclosure, such as, for example, with respect to FIGS. 1 and 2.

Modifications, additions, or omissions may be made to FIG. 3A without departing from the scope of the present disclosure. For example, the number of execution environments 302, the elements 304, the instances 306, the virtual interface 308 and the links 310 may vary. Additionally or alternatively, the layout of the visualization may change, the example visualization 300 is meant as an example of one embodiment displaying data corresponding to a particular view of an architectural model (e.g., the architectural model 114 and/or the architectural model 214). The specifics given and discussed are to help provide explanation and understanding of concepts of the present disclosure and are not meant to be limiting.

FIG. 3B illustrates an example visualization 350 showing an example visual representation of a behavioral model, in accordance with one or more embodiments of the present disclosure. In some embodiments, the visualization 350 may be an example of an output (e.g., the output 212) described and/or illustrated further in the present disclosure, such as, for example, with respect to FIG. 2. Additionally or alternatively, the example visualization 350 may be an example visual representation of a portion of one or more behavioral models described and/or illustrated further in the present disclosure, such as, for example, the behavioral model 116 and/or the behavioral model 216 in FIGS. 1 and/or 2.

In some embodiments, the example visualization 350 may include a linear progression or a sequence of multiple events corresponding to one or more users and/or elements associated with the system. In some embodiments, the example visualization 350 may be generated based on derived sequences corresponding to the behavioral model 216 and/or the input 222 as shown and/or described further in the present disclosure, such as, for example, with respect to FIG. 2.

The example visualization 350 may include a representation of a user 320. In some embodiments, the user 320 may provide one or more inputs that may originate outside the system corresponding to the example visualization 350. In some embodiments, the user 320 may provide one or more inputs that may originate outside the portion of the system corresponding to the example visualization 350.

The example visualization 350 may additionally include one or more elements which may include one or more software elements or hardware components included in the system associated with the example visualization 350. The example visualization 350 may include a first element 312A, a second element 312B, and a third element 312C. In these or other embodiments, the elements 312 may by the same as and/or analogous to events as described and/or illustrated further in the present disclosure, such as, for example, with respect to FIGS. 1, 2, and 3.

The example visualization 350 may additionally include one or more events 314 that may include one or more outputs and/or inputs between one or more elements 312 that may correspond to the system represented by the example visualization 350. The example visualization 350 may include a first event 314A, a second event 314B, a third event 314C, and a fourth event 314D. In some embodiments, the events 314 may indicate an input from, for example, a user 320 or other system, entity, etc. In some embodiments, the event 314A may represent the input provided by the user 320. In these or other embodiments, the events 314 may by the same as and/or analogous to events as described and/or illustrated further in the present disclosure, such as, for example, with respect to FIGS. 1 and 2.

An example sequence corresponding to the example visualization 350 may be provided and explained further below. For example, the first element 312A may include a virtualization system, the second element 312B may include a safety services element corresponding to the system, and the third element 312C may include a software element that may correspond to Power Management (PM) Firmware. Continuing the example, the virtualization system may be affected by a failure communicated using the event 314A. In response, the virtualization system (e.g., the first element 312A) may communicate the failure to two other elements (e.g., the safety services element and/or the PM Firmware element). In response to the communication associated with event 314B and 314C, the second element 312B and the third element 312C may perform one or more operations. Additionally or alternatively, the fourth event 314D may include direction to power down one or more CPU cores that may be associated with execution of one or more operations that may correspond to the second element 312B and the third element 312C. In some embodiments, the fourth event 314D may include a loop that may provide direction to power down each CPU core that may be associated with the second element 312B and the third element 312C.

Modifications, additions, or omissions may be made to FIG. 3A without departing from the scope of the present disclosure. For example, the number of outside inputs (e.g., provided by the user 320), the elements 312, and the events 314 may vary. Additionally or alternatively, the layout of the visualization may change, the example visualization 350 is meant as an example of one embodiment displaying an example sequence corresponding to a particular view of a behavioral model (e.g., the behavioral model 116 and/or the behavioral model 216). In some embodiments, the example visualization 350 may be altered or modified based on the level of abstraction, the elements included, the execution environment, etc. that may be associated with the system illustrated in the example visualization 350. The specifics given and discussed are to help provide explanation and understanding of concepts of the present disclosure and are not meant to be limiting.

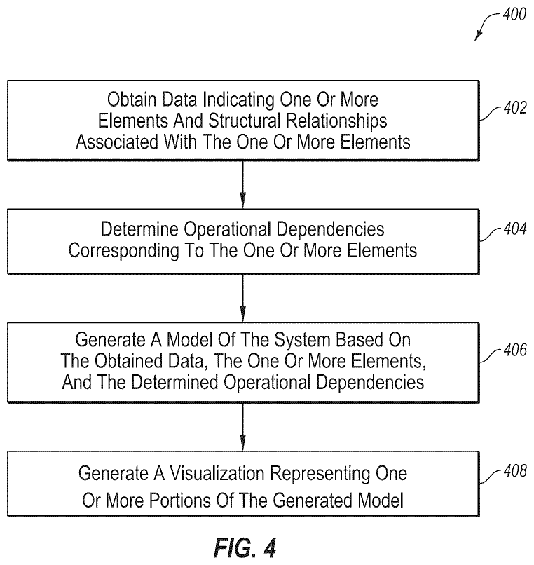

FIG. 4 is a flow diagram showing a method for generating one or more models associated with a system, in accordance with one or more embodiments of the present disclosure. In some embodiments, the method 400 may include generating one or more models based on obtained data, elements corresponding to the system, and determined operational dependencies, in accordance with one or more embodiments of the present disclosure. The method 400 may include one or more blocks 402, 404, 406. Although illustrated with discrete blocks, the operations associated with one or more of the blocks of the method 400 may be divided into additional blocks, combined into fewer blocks, or eliminated, depending on the particular implementation.

In some embodiments, the method 400 may include block 402. At block 402, data may be obtained where the data may indicate one or more elements corresponding to the system. In some embodiments, the obtained data may include first data and second data. In some embodiments, the first data may include one or more structural relationships between one or more elements. In some embodiments, the structural relationships may indicate one or more software elements or hardware components whose operation depends on one or more operations of the elements. In some embodiments, the first data may include one or more execution environments that may include one or more hardware components that may be associated with executing one or more of the elements associated with the system. Additionally or alternatively, the first data may include one or more links that may indicate possible interaction between two or more elements. Additionally or alternatively, the first data may include a level of abstraction that may correspond to one or more of the elements and/or the one or more execution environments.

In some embodiments, the obtained data may include second data. In some embodiments, the second data may indicate behavioral relationships between one or more of the elements associated with the system. In some embodiments, the behavioral relationships may indicate one or more operations that may be performed using the plurality of elements and a subset of the elements that may be affected by the operations that may have been performed. In some embodiments, the second data may include one or more logical interfaces. In some embodiments, the logical interfaces may represent one or more interactions between the one or more elements corresponding to the system. In some embodiments, the logical interfaces may be implemented using on or more virtual interfaces, where the virtual interfaces may individually indicate a boundary via which the one or more elements interact. Additionally or alternatively, the second data may include one or more interactions between the one or more virtual interfaces and one or more of the elements corresponding to the system. Additionally or alternatively, the second data may include a level of abstraction that may correspond to the one or more logical interfaces, the one or more virtual interfaces, and the one or more interactions.

At block 404, the method may additionally include determining operational dependencies that may correspond to the one or more elements. In some embodiments, the operational dependencies may be determined along with structural dependencies associated with the one or more elements in relationship to one or more of the other elements, the one or more execution environments, and the level of abstraction. Additionally or alternatively, a linear progression of events may be determined based on the second data, where an event may be defined by an interaction between two or more elements.

In some embodiments, determining operational dependencies may be determined using the model generation tool 102 or 210, the computing system 202, and/or the verification tool 218 as described and/or illustrated further in the present disclosure, such as, for example, with respect to FIGS. 1 and 2. In some embodiments, the obtained data may correspond to one or more systems about which data may have already been received or about which data may be iteratively received. In some embodiments, the obtained data may therefore be verified against corresponding data to determine whether the structural dependencies and/or the operational dependencies may comport with previously received data. In some embodiments, the obtained data may be verified using one or more systems, subsystems, tools, etc. such as, for example, the verification tool 218 that may be described and/or illustrated in FIG. 2.

At block 406, the method may additionally include generating a model of the system based on the obtained data, the one or more elements, and the determined operational dependencies. In some embodiments, the model may be generated based on the determined operational dependencies, the determined structural dependencies, and the level of abstraction. In some embodiments, the generated model may be modifiable based on the level of abstraction. In some embodiments, the generated model may include an architectural model and/or a behavioral model that may individually be generated and/or modified based on the level of abstraction.

At block 408, the method may additionally include generating one or more visualizations. In some embodiments, the one or more visualizations may be generated based on the behavioral model and/or the architectural model. In some embodiments, the one or more visualizations may represent one or more portions of the generated model, where the one or more portions of the generated model may be indicated using the input. In some embodiments, the one or more visualizations may include visual graphics, images, text, etc., that may represent or indicate the one or more portions of the generated model. In some embodiments, the input may indicate which portion(s) may be represented by the one or more generated visualizations. For example, the input may indicate a particular element corresponding to the system that the visualization may then represent. In some embodiments, the input may be received by one or more other sources—e.g., a user, a system, a large language model, a machine learning model, a deep neural network, etc. In some embodiments, the input may include, for example, at least one of a particular element, a virtual interface, a level of abstraction, or an execution environment.

In some embodiments, the visualizations generated based on the model may be more consumable and may increase the efficacy with which developers may rely on the visualizations to make hardware or software changes to the system as compared with previously conceived manually updated visualizations. In addition, the information corresponding to the model(s) and/or visualization(s) may be consumed and/or used in safety-hardened products. In some instances, the models and/or visualizations may be used for safety verifications and/or certification.

Modifications, additions, or omissions may be made to the method 400 and/or one or more operations included in the method 400 without departing from the scope of the present disclosure. For example, the operations corresponding to the method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more CPU(s), system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, and/or to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) 546 (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the HD map 522 of FIG. 5C), location data (e.g., the location of the vehicle 500, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524, which may use one or more wireless antenna(s) 526 and/or modem(s) to communicate over one or more networks. For example, the network interface 524 may be capable of communication over LTE, WCDMA, UMTS, GSM, CDMA2000, etc. The wireless antenna(s) 526 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward-facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may any number of wide-view cameras 570 on the vehicle 500. In addition, long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

One or more stereo cameras 568 may also be included in a front-facing configuration. The stereo camera(s) 568 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360-degree camera(s), and/or the like. For example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround-view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C is illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500 and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting, and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected to both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 516 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe-stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always-on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528, which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPD (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data, in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surrounding at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 100 m, with an accuracy of 2 cm-3 cm, and with support for a 100 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200 m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 500), while the 12V communication concept provides information about traffic further ahead. CACC systems may include either or both I2V and V2V information sources. Given the information of the vehicles ahead of the vehicle 500, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network that is trained and thus reduces the risk of false positives, as described herein.

The vehicle 500 may further include the infotainment SoC 530 (e.g., an in-vehicle infotainment system (IVI)). Although illustrated and described as an SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 500. For example, the infotainment SoC 530 may include radios, disk players, navigation systems, video players, USB and Bluetooth connectivity, carputers, in-car entertainment, Wi-Fi, steering wheel audio controls, hands-free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe-stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point, connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, include wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, etc.), and output the data (e.g., as an image, video, sound, etc.).

### Example Data Center

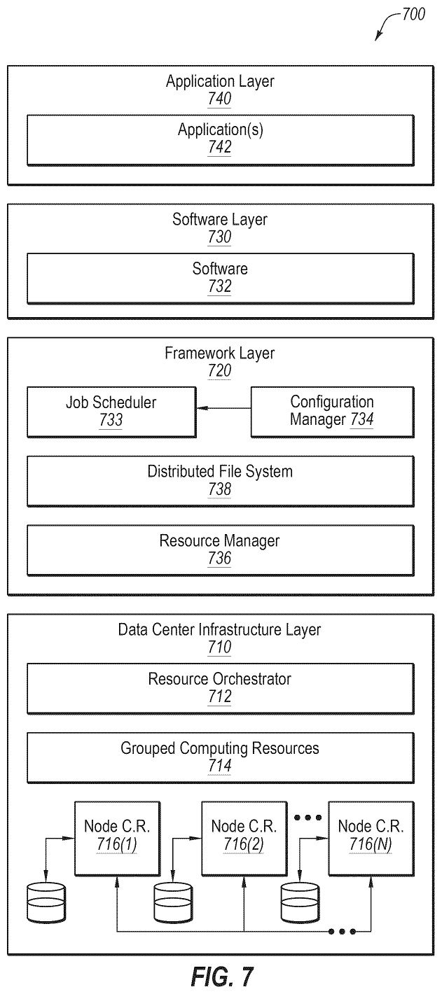

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 732, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 700. In at least one embodiment, trained or deployed machine learning models corresponding to one or more neural networks may be used to infer or predict information using resources described in the present disclosure with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Example 1. A method may include:
obtaining data indicating a plurality of elements, wherein each of the plurality of elements is associated with functionality of a system;
determining operational dependencies corresponding to the plurality of elements in relation to one or more of the other plurality of elements included in the obtained data;
generating a model of the system based on the obtained data, the plurality of elements, and the determined operational dependencies, wherein the generated model is configured to be modified or queried based on an input; and
generating a visualization representing one or more portions of the generated model indicated by the input.

The method included in example 1, wherein the obtained data includes:
first data that indicates structural relationships between one or more of the plurality of elements, the structural relationships indicating one or more software elements or hardware components whose operation depends on one or more operations of the plurality of elements; and
second data that indicates behavioral relationships between one or more of the plurality of elements, the behavioral relationships indicating operations performed using the plurality of elements and a subset of the plurality of elements affected by the operations performed.

The method included in Example 1, wherein the first data further includes data indicating:
one or more execution environments including one or more hardware components associated with executing one or more of the plurality of elements;
one or more links indicating possible interaction between two or more elements of the plurality of elements; and
a level of abstraction corresponding to one or more of the plurality of elements and the one or more execution environments.

The method included in Example 1, further comprising:
determining operational dependencies and structural dependencies corresponding to the plurality of elements in relation to one or more of the other plurality of elements, the one or more execution environments, and the level of abstraction; and
generating the model of the system based on the first data, the determined operational dependencies, and the determined structural dependencies, wherein the generated model is configured to be modified based on the level of abstraction.

The method included in Example 1, wherein the generated model is an architectural model that is configured to be modified based on the level of abstraction.

The method included in Example 1, wherein the second data further includes data indicating:
one or more logical interfaces, each representing one or more interactions between the one or more elements;
one or more virtual interfaces, each indicating a boundary via which the one or more elements interact;
one or more interactions between the one or more interfaces and one or more of the plurality of elements corresponding to the system; and
a level of abstraction corresponding to the one or more logical interfaces, the one or more virtual interfaces, and the one or more interactions.

The method included in Example 1, further comprising: determining a linear progression of events based on the second data, wherein an event in the determined linear progression of events is defined by an interaction between two or more elements of the plurality of elements; and
generating the model of the system based on the first data, the second data, the determined linear progression, and the level of abstraction.

The method included in Example 1, wherein the generated model is a behavioral model that is configured to be modified based on the level of abstraction.

The method included in Example 1, further comprising: obtaining input for the level of abstraction; and
generating a visualization of the system based at least on the behavioral model and the obtained input.

The method included in Example 1, further comprising: iteratively obtaining first data and second data, wherein the first data and the second data are verified against previously obtained first data and second data;
alerting to first data and second data that does not comport with the previously obtained first data and second data; and
iteratively generating architectural models or behavioral models based on the iteratively obtained first data and second data.

The method included in Example 1, wherein the plurality of elements includes both software elements and hardware components.

The method included in Example 1, wherein the input includes an indication of at least one of a particular element, a virtual interface, a level of abstraction, or an execution environment.

Example 2. A system may include:
one or more processors comprising processing circuitry to perform operations comprising:
obtaining first data indicating a plurality of elements, wherein each of the plurality of elements is associated with functionality of a system, the first data indicating structural relationships between one or more of the plurality of elements, the structural relationship indicating one or more software elements or hardware components whose operation depends on one or more operations of the plurality of elements; and
obtaining second data that indicates behavioral relationships between one or more of the plurality of elements, the behavioral relationships indicating operations performed using the plurality of elements and a subset of the plurality of elements affected by the operations performed;
determining operational dependencies and structural dependencies corresponding to the plurality of elements in relation to one or more of the other plurality of elements; and
generating a model of the system based on the first data, the second data, the determined operational dependencies, and the determined structural dependencies, wherein the generated model is configured to be modified or queried based on an input;
generating a visualization representing one or more portions of the generated model indicated by the input.

The system included in Example 2, wherein the second data further includes data indicating:
one or more logical interfaces, representing one or more interactions between the one or more elements;
one or more virtual interfaces, each indicating a boundary via which the one or more elements interact;
one or more interactions between the one or more interfaces and one or more of the plurality of elements corresponding to the system; and
a level of abstraction corresponding to the one or more logical interfaces, the one or more virtual interfaces, and the one or more interactions.

The system included in Example 2, the operations further comprising:
determining a linear progression of events based on the second data, wherein an event in the determined linear progression of events is defined by an interaction between two or more elements of the plurality of elements; and
generating the model of the system based on the first data, the second data, the determined linear progression, and the level of abstraction.

The system included in Example 2, the operations further comprising:
iteratively obtaining first data and second data, wherein the first data and the second data is verified against previously obtained first data and second data;
alerting to first data and second data that does not comport with the previously obtained first data and second data; and
iteratively generating architectural models or behavioral models based on the iteratively obtained first data and second data.

The system included in Example 2, wherein the input includes an indication of at least one of a particular element, a virtual interface, a level of abstraction, or an execution environment.

Example 3. A processor comprising processing circuitry to perform operations comprising:
obtaining first data indicating a plurality of elements, wherein each of the plurality of elements is associated with functionality of a system, the first data indicating structural relationships between one or more of the plurality of elements, the structural relationships individually indicating one or more software elements or hardware components whose operation depends on one or more operations of the plurality of elements; and
obtaining second data that indicates behavioral relationships between one or more of the plurality of elements, the behavioral relationships indicating operations performed using the plurality of elements and a subset of the plurality of elements affected by the operations performed;
determining operational dependencies and structural dependencies corresponding to the plurality of elements in relation to one or more of the other plurality of elements; and
generating a model of the system based on the first data, the second data, the determined operational dependencies, and the determined structural dependencies.

The processor included in Example 3, wherein the second data further includes data indicating:
one or more logical interfaces, representing one or more interactions between the one or more elements;
one or more virtual interfaces, each indicating a boundary via which the one or more elements interact;
one or more interactions between the one or more interfaces and one or more of the plurality of elements corresponding to the system; and
a level of abstraction corresponding to the one or more logical interfaces, the one or more virtual interfaces, and the one or more interactions.

The processor included in Example 3, the operations further comprising: determining a linear progression of events based on the second data, wherein an event in the determined linear progression of events is defined by an interaction between two or more elements of the plurality of elements; and
generating the model of the system based on the first data, the second data, the determined linear progression, and the level of abstraction.

The processor included in Example 3, the operations further comprising: iteratively obtaining first data and second data, wherein the first data and the second data is verified against previously obtained first data and second data;
alerting to first data and second data that does not comport with the previously obtained first data and second data; and
iteratively generating architectural models or behavioral models based on the iteratively obtained first data and second data.

The processor included in Example 3, where the processor is included in a system, the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system for generating synthetic data;
a system incorporating one or more virtual machines (VMs);
a system implemented at least partially in a data center, or
a system implemented at least partially using cloud computing resources.

What is claimed is:

1. A method comprising:
obtaining data indicating a plurality of elements, individual elements of the plurality of elements being associated with a respective functionality of a system;
determining operational dependencies corresponding to individual elements of the plurality of elements in relation to one or more other individual elements of the plurality of elements indicated by the data; and
generating a model of the system based at least on the obtained data, the plurality of elements, and the operational dependencies;
receiving one or more inputs indicating a modification or a query related to the model; and
generating a visualization representing one or more portions of the generated model indicated by the one or more inputs.

2. The method of claim 1, wherein the obtained data includes:
first data that indicates structural relationships between one or more elements of the plurality of elements, the structural relationships indicating one or more software elements or hardware components whose operation depends on one or more operations of the plurality of elements; and
second data that indicates behavioral relationships between one or more elements of the plurality of elements, the behavioral relationships indicating operations performed using the plurality of elements and a subset of the plurality of elements affected by the operations performed.

3. The method of claim 2, wherein the first data further includes data indicating:
one or more execution environments including one or more hardware components associated with executing one or more elements of the plurality of elements;
one or more links indicating possible interaction between two or more elements of the plurality of elements; and
a level of abstraction corresponding to one or more elements of the plurality of elements and the one or more execution environments.

4. The method of claim 3, further comprising:
determining operational dependencies and structural dependencies corresponding to the plurality of elements in relation to one or more elements of the other plurality of elements, the one or more execution environments, and the level of abstraction; and
generating the model of the system based at least on the first data, the determined operational dependencies, and the determined structural dependencies, wherein the generated model is configured to be modified based at least on the level of abstraction.

5. The method of claim 4, wherein the generated model is an architectural model that is configured to be modified based at least on the level of abstraction.

6. The method of claim 2, wherein the second data further includes data indicating:
one or more logical interfaces each representing one or more interactions between the one or more elements;
one or more virtual interfaces each indicating a boundary via which the one or more elements interact;
one or more interactions between the one or more interfaces and one or more elements of the plurality of elements corresponding to the system; and
a level of abstraction corresponding to the one or more logical interfaces, the one or more virtual interfaces, and the one or more interactions.

7. The method of claim 6, further comprising:
determining a linear progression of events based at least on the second data, wherein an event in the determined linear progression of events is defined by an interaction between two or more elements of the plurality of elements; and
generating the model of the system based at least on the first data, the second data, the determined linear progression, and the level of abstraction.

8. The method of claim 7, wherein the generated model is a behavioral model that is configured to be modified based at least on the level of abstraction.

9. The method of claim 8, further comprising:
obtaining input for the level of abstraction; and
generating a visualization of the system based at least on the behavioral model and the obtained input.

10. The method of claim 2, further comprising:
iteratively obtaining first data and second data, wherein the first data and the second data are verified against previously obtained first data and previously obtained second data;
alerting to first data and second data that does not comport with the previously obtained first data and the previously obtained second data; and
iteratively generating architectural models or behavioral models based at least on the iteratively obtained first data and the iteratively obtained second data.

11. The method of claim 1, wherein the input includes an indication of at least one of a particular element, a virtual interface, a level of abstraction, or an execution environment.

12. A system comprising:
one or more processors comprising processing circuitry to perform operations comprising:
obtaining first data indicating a plurality of elements, individual elements of the plurality of elements being associated with a respective functionality of a system, the first data indicating structural relationships between one or more elements of the plurality of elements, the structural relationship indicating one or more software elements or hardware components whose operation depends on one or more operations of the plurality of elements; and
obtaining second data that indicates behavioral relationships between one or more elements of the plurality of elements, the behavioral relationships indicating operations performed using the plurality of elements and a subset of the plurality of elements affected by the operations performed;
determining operational dependencies and structural dependencies corresponding to individual elements of the plurality of elements in relation to one or more other individual elements of the other plurality of elements; and
generating a model of the system based at least on the first data, the second data, the operational dependencies, and the structural dependencies;
receiving one or more inputs indicating a modification or a query related to the model;
generating a visualization representing one or more portions of the generated model indicated by the one or more inputs.

13. The system of claim 12, wherein the second data further includes data indicating:
one or more logical interfaces, representing one or more interactions between the one or more elements;
one or more virtual interfaces, each indicating a boundary via which the one or more elements interact;
one or more interactions between the one or more interfaces and one or more elements of the plurality of elements corresponding to the system; and
a level of abstraction corresponding to the one or more logical interfaces, the one or more virtual interfaces, and the one or more interactions.

14. The system of claim 13, the operations further comprising:
determining a linear progression of events based at least on the second data, wherein an event in the determined linear progression of events is defined by an interaction between two or more elements of the plurality of elements; and
generating the model of the system based at least on the first data, the second data, the determined linear progression, and the level of abstraction.

15. The system of claim 12, the operations further comprising:
iteratively obtaining first data and second data, wherein the first data and the second data is verified against previously obtained first data and second data;
alerting to first data and second data that does not comport with the previously obtained first data and second data; and
iteratively generating architectural models or behavioral models based at least on the iteratively obtained first data and second data.

16. The system of claim 12, wherein the input includes an indication of at least one of a particular element, a virtual interface, a level of abstraction, or an execution environment.

17. A processor comprising processing circuitry to perform operations comprising:
obtaining first data indicating a plurality of elements, individual elements of the plurality of elements being associated with a respective functionality of a system, the first data indicating structural relationships between one or more elements of the plurality of elements, the structural relationships individually indicating one or more software elements or hardware components whose operation depends on one or more operations of the plurality of elements; and
obtaining second data that indicates behavioral relationships between one or more elements of the plurality of elements, the behavioral relationships indicating operations performed using the plurality of elements and a subset of the plurality of elements affected by the operations performed;
determining operational dependencies and structural dependencies corresponding to individual elements of the plurality of elements in relation to one or more other individual elements of the other plurality of elements; and
generating a model of the system based at least on the first data, the second data, the determined operational dependencies, and the determined structural dependencies.

18. The processor of claim 17, wherein the second data further includes data indicating:
one or more logical interfaces, representing one or more interactions between the one or more elements;
one or more virtual interfaces, each indicating a boundary via which the one or more elements interact;
one or more interactions between the one or more interfaces and one or more elements of the plurality of elements corresponding to the system; and
a level of abstraction corresponding to the one or more logical interfaces, the one or more virtual interfaces, and the one or more interactions.

19. The processor of claim 18, the operations further comprising:
determining a linear progression of events based at least on the second data, wherein an event in the determined linear progression of events is defined by an interaction between two or more elements of the plurality of elements; and
generating the model of the system based at least on the first data, the second data, the determined linear progression, and the level of abstraction.

20. The processor of claim 17, the operations further comprising:
iteratively obtaining first data and second data, wherein the first data and the second data is verified against previously obtained first data and second data;
alerting to first data and second data that does not comport with the previously obtained first data and second data; and
iteratively generating architectural models or behavioral models based at least on the iteratively obtained first data and second data.
